(19) United States
(12) Patent Application Publication
(10) Pub. No.: US 2024/0378228 A1
(43) Pub. Date: Nov. 14, 2024

(54) Delivering Items in Different Modes Using Shared Processing Resources

(71) Applicant: Microsoft Technology Licensing, LLC, Redmond, WA (US)

(72) Inventors: Yanjun LIU, Mercer Island, WA (US); Jian JIAO, Bellevue, WA (US)

(73) Assignee: Microsoft Technology Licensing, LLC, Redmond, WA (US)

(21) Appl. No.: 18/195,410

(22) Filed: May 10, 2023

(51) Int. Cl. G06F 16/38; G06F 16/33

(52) U.S. Cl. CPC G06F 16/38; G06F 16/3347

(57) ABSTRACT

A technique serves information items associated with at least two item-serving modes using shared resources. For example, the technique delivers dynamic search ads in a dynamic search ad (DSA) mode using processing resources that were originally developed for serving text ads in a text ad (TA) mode. In a first aspect, the technique repurposes a part of the TA-mode processing flow to find a set of landing pages associated with a query. In a second aspect, the technique performs further processing based on output results generated by the TA-mode processing flow, with the objective of identifying a set of landing pages associated with the query. Overall, the technique reduces the consumption of resources in the serving of ads, and simplifies the maintenance of an ad-serving system. The technique also allows one mode to use algorithmic advances developed for use in another mode.

### BACKGROUND

The manner in which a search engine serves ads often reflects historical considerations, principally with regard to the way in which ad-serving technology has evolved over the years. For instance, an ad-serving platform may have initially devoted a first processing flow for serving text ads associated with advertiser-specified keywords. The ad-serving platform applies the first processing flow by matching a user's query with a keyword, and then serving a text ad that has been previously associated with the identified keyword. Later, the ad-serving platform may have developed a second processing flow for serving dynamic search ads associated with landing pages specified by advertisers. The ad-serving platform applies the second processing flow by matching a user's query with a landing page, and then serving a dynamic search ad that corresponds to the user's query and the identified landing page. In some cases, the search engine automatically creates at least part of the dynamic search ad (such as its headline) based on the user's query and the content of the landing page. A dynamic search ad campaign also frees the user from the labor-intensive and time-intensive task of manually specifying keywords associated with their products and services. Because the first and second flows were developed at separate times to serve different objectives, these two flows rely on separate and distinct processing models and algorithms.

### SUMMARY

A technique is described for serving information items associated with at least two item-serving modes using shared resources. For example, the technique delivers dynamic search ads in a dynamic search ad (DSA) mode using processing resources that were originally developed for serving text ads in a text ad (TA) mode.

A first aspect of the technique repurposes a part of the TA-mode processing flow to serve dynamic search ads. In particular, the technique encodes the input query into a query embedding. The technique then performs a nearest-neighbor search to find landing page embeddings that are closest to the query embedding in a vector space. The landing page embeddings are associated with respective landing pages. The technique then generates dynamic search ads based, at least in part, on the identified landing pages. The encoding and search functionality were originally developed for serving text ads in the TA mode, but are repurposed in this implementation to now play a part in the serving of dynamic search ads in the DSA mode.

A second aspect of the technique performs further DSA processing on output results generated in the TA mode, with the objective of serving dynamic search ads. In particular, the technique performs a nearest-neighbor search to find keyword embeddings that are closest to the query embedding in the vector space. The keyword embeddings are associated with respective keywords. The technique then maps the keywords into respective landing pages. The technique then generates dynamic search ads based on the identified landing pages, optionally along with landing pages identified by other keyword-identifying techniques. The process of identifying keywords was originally developed for serving text ads in the TA mode, but is applied in this implementation as a first stage in the serving of dynamic search ads.

The technique reduces the consumption of resources because two formerly separate processing flows are now implemented using shared resources. The technique also simplifies the maintenance of the two processing flows because it reduces the number of operations that are unique to each processing path. The technique also allows the functionality associated with the DSA mode to benefit from the advanced algorithms that have been developed for use in the TA mode. The technique also provides certain latency-related benefits specified herein.

This Summary is provided to introduce a selection of concepts in a simplified form; these concepts are further described below in the Detailed Description. This Summary is not intended to identify key features or essential features (or key/essential advantages) of the claimed subject matter, nor is it intended to be used to limit the scope of the claimed subject matter.

### BRIEF DESCRIPTION OF THE DRAWINGS

FIG. 1 shows an overview of a computing system having an ad-serving system for serving text ads in a text ad (TA) mode.

FIG. 2 shows an overview of how the computing system of FIG. 1 serves dynamic search ads in a dynamic search ad (DSA) mode.

FIG. 3 shows a mechanism by which the ad-serving system of FIG. 2 serves dynamic search ads in accordance with a first step.

FIG. 4 shows a mechanism by which the ad-serving system of FIG. 2 serves dynamic search ads in accordance with a second step.

FIG. 5 shows functionality for mapping a query and a landing page to two respective embeddings in a vector space.

FIG. 6 shows functionality for mapping a query and a keyword to two respective embeddings in a vector space.

FIG. 7 shows a transformer-based model that can be used to implement various components of the computing system of FIGS. 1 and 2.

FIG. 8 shows an encoder component, which can be used to implement various functions of the ad-serving system of FIGS. 3 and 4.

FIG. 9 shows a decoder component, which can be used to implement various functions of the ad-serving system of FIGS. 3 and 4.

FIG. 10 shows an encoder-decoder component, which can be used to implement various functions of the ad-serving system of FIGS. 3 and 4.

FIG. 11 shows a process that represents one manner of operation of the ad-serving system, in accordance with the resource-sharing configuration of FIG. 3.

FIG. 12 shows a process that represents another manner of operation of the ad-serving system, in accordance with the resource-sharing configuration of FIG. 4.

FIG. 13 shows computing equipment that, in some implementations, is used to implement the computing system of FIGS. 1 and 2.

FIG. 14 shows an illustrative type of computing system that, in some implementations, is used to implement any aspect of the features shown in the foregoing drawings.

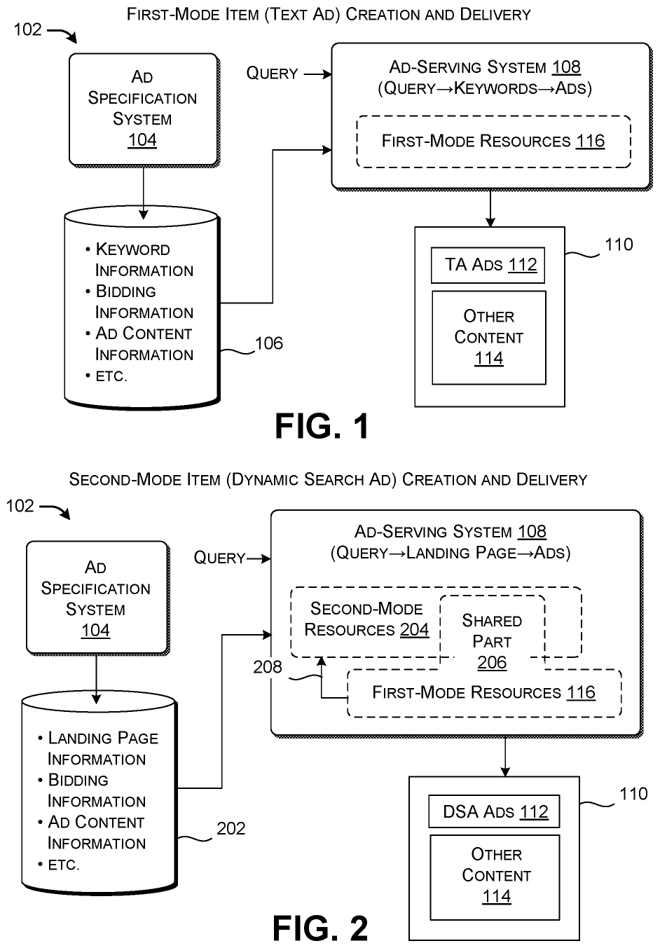

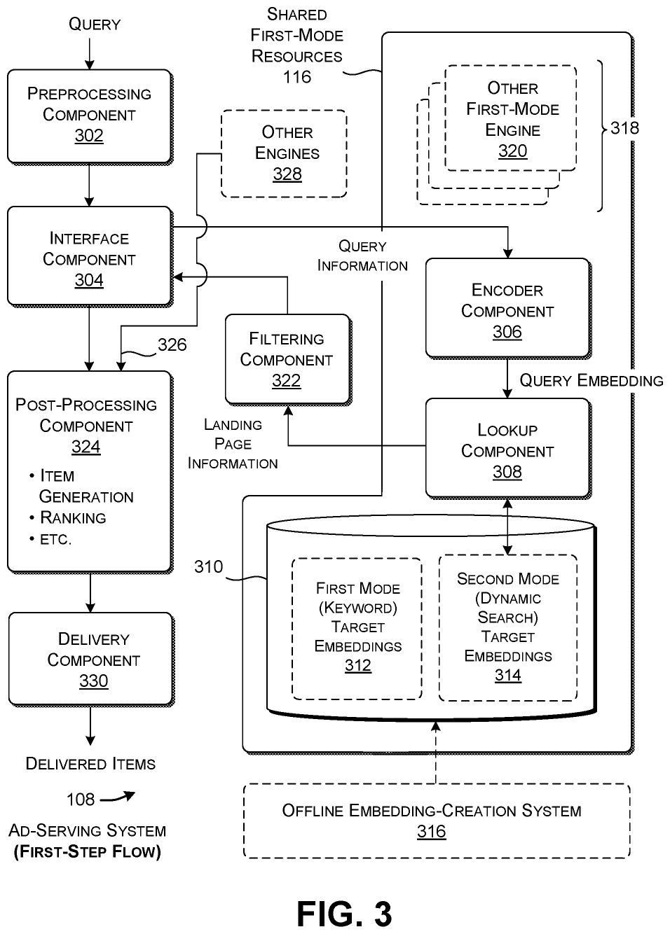

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

FIG. 1 shows an overview of a computing system 102 for delivering text ads in a text ad (TA) mode. An ad specification system 104 allows an advertiser to create an ad campaign involving text ads. Typically, the advertiser performs this function by specifying a set of keywords, bidding information, and ad content information associated with each text ad. A data store 106 stores the collected information.

In a production (inference) stage, an ad-serving system 108 receives a query specified by a user via a user. A “query” encompasses any text explicitly entered by the user (e.g., via a search interface of a search engine), and/or any text with which the user is currently interacting (e.g., by reading a message provided by a message-sending application), etc. The ad-serving system 108 identifies a set of keywords that match the query. The ad-serving system 108 then identifies text ads that have been previously associated with those keywords. As used herein, a “keyword” is to be understood as any instance of keyword information, and may include one or more words. For example, the string “Dog groomers for Poodles in Seattle” is considered a keyword. The ad-serving system 108 performs the above-described functions using first-mode resources 116. In part, the first-mode resources 116 include a plurality of keyword-identifying engines for mapping the query into a set of keywords. That is, each keyword-identifying engine identifies a different subset of keywords based on the query.

The ad-serving system 108 delivers the text ads to the user in any form. In some cases, for instance, the ad-serving system 108 works in conjunction with a search engine (not shown). The search engine provides a search results page that shows a list of items that match the user's query. In some implementations, the ad-serving system 108 displays the text ads as part of the search results page, e.g., as an annotated set of entries at the beginning of the list of search result items. FIG. 1 specifically shows an example in which a user interface presentation 110 mixes ad content 112 with other content 114 (e.g., corresponding to the organic search results provided by the search engine).

FIG. 2 shows an overview of the manner in which the computing system 102 of FIG. 1 delivers dynamic search ads in a dynamic search ad (DSA) mode. In this context, the ad specification system 104 allows an advertiser to create an ad campaign involving dynamic search ads. Typically, the advertiser performs this function by specifying a one or more landing pages and bidding information. The advertiser may optionally specify content associated with each dynamic search ad. (Alternatively, or in addition, in the production stage, the computing system 102 creates the content of each dynamic search ad based on text of a particular query and the content associated with a landing page.) A data store 202 stores the collected information.

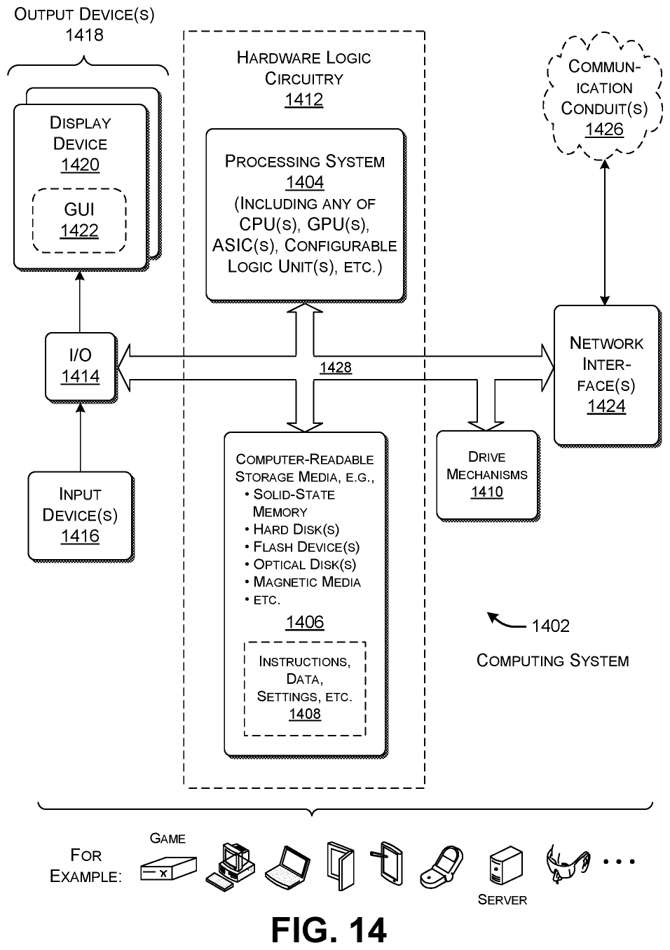

By way of terminology, a “machine-trained model” refers to computer-implemented logic for executing a task using machine-trained weights that are produced in a training operation. A “weight” refers to any type of parameter value that is iteratively produced by the training operation. In some contexts, terms such as “component,” “module,” “engine,” and “tool” refer to parts of computer-based technology that perform respective functions. FIGS. 13 and 14, described below, provides an example of illustrative computing equipment for performing these functions.

In some cases, the process of creating a dynamic search ad campaign is simpler than the process of creating a text ad campaign, as it does not require the advertiser to identify specific keywords associated with specific ads. Nor does a dynamic search ad campaign require the advertiser to input bidding information on the same granular level as some text ad campaigns. Nevertheless, in some cases, an advertiser may wish to advertise the same set of goods or services using both a text ad campaign and a dynamic search ad campaign, because the different campaigns may be effective in targeting different aspects of the advertiser's goods and services.

In the production stage, the ad-serving system 108 receives a query specified by a user. The ad-serving system 108 identifies a set of landing pages that match the query. The ad-serving system 108 then generates dynamic search ads for the identified landing pages. The ad-serving system 108 serves the dynamic search ads to the user in any form, such as the manner specified above for FIG. 1.

FIG. 2 generally indicates that the ad-serving system 108 delivers dynamic search ads using second-mode resources 204 in combination with at least some of the first-mode resources 116 used in the TA mode to deliver text ads. More specifically, the ad-serving system 108 fuses the processing flows associated with the TA mode and the DSA mode in two different ways.

That is, according to a first aspect (referred herein as a “first step” herein), the ad-serving system 108 repurposes some of the components of the first-mode resources 116 to identify a set of landing pages based on the query. To accomplish this result, the ad-serving system 108 does not modify the logic of the repurposed components of the first-mode resources 116, but rather, in part, modifies the type of data to which these components are applied. FIG. 2 illustrates the first aspect by showing that a part 206 of the first-mode resources 116 are also used by the second-mode resources 204, and therefore this part 206 is shared.

According to a second aspect (referred to herein as a “second step” herein), the ad-serving system 108 performs further downstream processing on output results generated in the TA mode, with the objective of generating a set of landing pages associated with the query. In other words, in the second step, the ad-serving system 108 provides a new post-processor that maps the original (unmodified) output results of the TA mode to new output results which are consumable by the DSA mode. Here, the output results of the components of the first-mode resources 116 have the same meaning in the TA mode and the DSA mode. FIG. 2 illustrates the second aspect by showing a path 208 whereby output results generated by the first-mode resources feed into the second-mode resources 204.

In some cases, the ad-serving system 108 performs the first step without the second step. In other cases, the ad-serving system 108 performs the second step without the first step. In other cases, the ad-serving system 108 performs both the first step and the second step. For example, in the second step, the ad-serving system 108 uses plural techniques to generate different subsets of landing pages, one technique of which is the process associated with the first step. Here, the second step can be said to follow the first step.

The sharing configuration shown in FIG. 2 alters an entrenched manner of implementing different ad-serving services. That is, formerly, the first-mode resources 116 and the second-mode resources 204 were separate and distinct. That is, the first-mode resources 116 used algorithms and models that were not shared by the algorithms and models used in the second-mode resources 204. Further, the first-mode resources 116 and the second-mode resources 204 required separate maintenance. The implementation of FIG. 2 integrates the two separate flows.

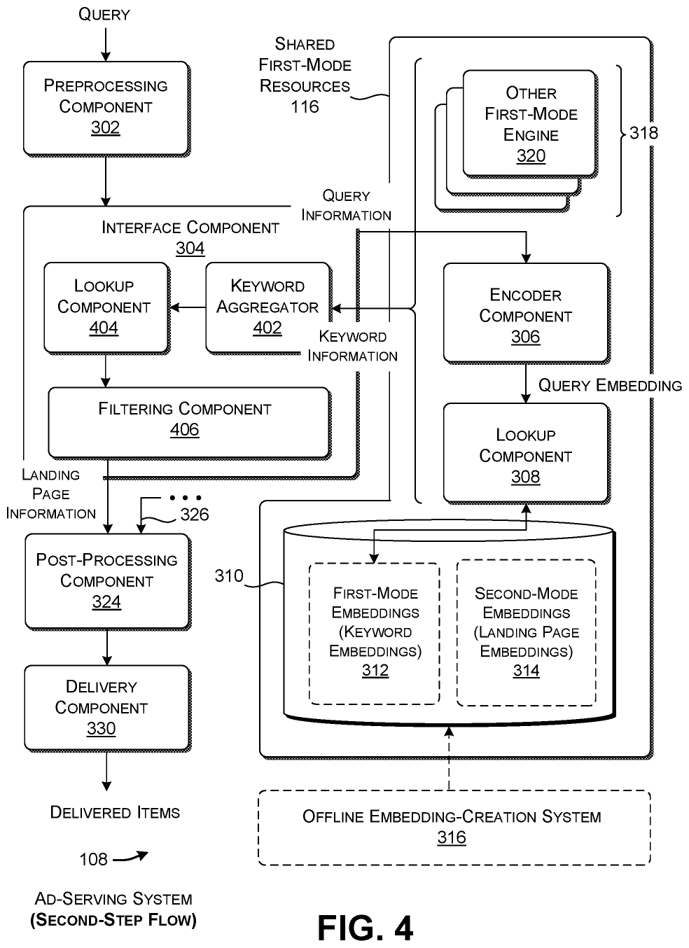

FIGS. 3 and 4 show further details regarding the mechanisms by which the ad-serving system 108 executes the DSA-mode processing flow. In particular, FIG. 3 shows the first step of the DSA mode, while FIG. 4 shows the second step of the DSA mode. In some implementations, the second step follows the first step. However, as noted above, some implementations apply the first step without performing the second step, or vice versa. Although not represented by FIGS. 3 and 4, the ad-serving system 108 can simultaneously serve text ads in the TA mode using the first-mode resources 116. In other words, for a single query, the ad-serving system 108 can serve text ads using the first-mode resources 116 and dynamic search ads using a combination of the first-mode resources 116 and the second-mode resources 204.

Starting with FIG. 3, a preprocessing component 302 preprocesses a query submitted by a user. In some implementations, preprocessing operations include any of: a) decomposing the query into text tokens; b) identifying features associated with the query; c) removing stop words associated with the query; d) performing grammar-checking on the query; e) determining whether the query originates from a malicious entity (such as a BOT); f) determining a category associated with the query; g) identifying any entity mentions in the query, and so on. Some of the query's features describe lexical and/or semantic characteristics of the text that composes the query. Other features describe the context in which the query was submitted. These context-based features describe any of: a) the characteristics of the user who submitted the query; b) the location from which the query was submitted; c) the time at which the query was submitted, and so on. The preprocessing component 302 outputs query information based on its analysis.

An interface component 304 operates as a hub, performing various functions that govern the flow of operations in the first and second steps. The functions include any of load-balancing, routing, collecting results, organizing results, etc. For example, the interface component 304 routes the query information received from the preprocessing component 302 to the first-mode resources 116. The interface component 304 also receives output results generated by the first-mode resources 116. As explained above (in connection with FIG. 1), the first-mode resources 1116 were originally developed for implementing the TA mode, and continue to implement the TA mode in the context of serving text ads.

Upon receiving the query information, an encoder component 306 uses a machine-trained model (not shown) to map the query information to a query embedding. In some implementations, the machine-trained model corresponds to any type of neural network, including any of a feed-forward neural network, a convolutional neural network (CNN), a transformer-based neural network, etc. In some implementations, the query embedding produced by the encoder component 306 is a distributed vector. A distributed vector is a vector that expresses the meaning of the query information based on a combination of values distributed over its d dimensions. A distributed vector differs from a sparse one-hot vector, which allocates a particular concept to each of its dimensions in a fixed manner.

A lookup component 308 identifies a set of target item embeddings stored in a data store 310 that are closest to the query embedding produced by the encoder component 306. The lookup component 308 performs this task in any manner, such as by performing an exhaustive search through a vector space, or performing any type of nearest neighbor search technique, such as the approximate nearest neighbor (ANN) technique. Background information on the general topic of the approximate nearest neighbor searching can be found at Indyk, et al., “Approximate Nearest Neighbors: Towards Removing the Curse of Dimensionality,” in STOC '98: Proceedings of the Thirtieth Annual ACM Symposium on Theory of Computing, May 1998, pp. 604-613. Background information on the more general topic of nearest neighbor search techniques can be found at Bhatia, et al., “Survey of Nearest Neighbor Techniques,” in (IJCSIS) International Journal of Computer Science and Information Security, Vol. 8, No. 2, 2010, pp. 302-305.

The data store 310 stores a first set 312 of keyword embeddings and a second set 314 of landing page embeddings. In the first step, the lookup component 308 specifically performs its search over the landing page embeddings of the second set 314. That is, the lookup component 308 finds an initial set of landing page embeddings in the second set 314 that are closest to the query embedding. The lookup component 308 can use any distance metric to assess “closeness,” including inner product, cosine similarity, Euclidean distance, etc. As a result of its processing, the lookup component 308 identifies a set of landing pages (associated with the closest landing page embeddings).

An embedding-creation system 316 produces the target item embeddings in the data store 310 in a prior offline process. For instance, the embedding-creation system 316 produces the first set 312 of target item embeddings by mapping keywords to respective keyword embeddings using the encoder component 306. The embedding-creation system 316 produces the second set 314 of target item embeddings by mapping landing pages specified by the advertisers (via the ad specification system 104) to respective landing page embeddings using the encoder component 306. The data store 310 stores each target item embedding together with metadata pertaining to the target item embedding. For example, an entry in the first set 312 identifies a text ad associated with a particular keyword embedding, e.g., by identifying the ID associated with this text add. An entry in the second set 314 identifies a landing page associated with a particular landing page embedding, e.g., by identifying the ID associated with this dynamic search ad.

The first-mode resources 116 include other first-mode engines 318 besides the components described above. A first-mode engine 320 is one such engine. These other first-mode engines 318 do not play a role in the first step shown in FIG. 3 for serving dynamic search ads, but are described in further detail below with respect to the second step (shown in FIG. 4).

A filtering component 322 filters the set of landing page identifiers produced by the lookup component 308 based on one or more filtering factors. In some implementations, the filtering component 322 determines the semantic similarity between the query and each landing page, e.g., by determining the distance between a first distributed vector that represents the query and a second distributed vector that represents the landing page. The filtering component 322 excludes any landing page having a distance measure that does not satisfy an environment-specific threshold value. Alternatively, or in addition, the filtering component 322 excludes any landing page having a popularity (e.g., as measured by selection rate) below a prescribed threshold value. Alternatively, or in addition, the filtering component 322 excludes any landing page that has a specified kind of content, and so on. As described above, the filtering component 322 analyzes the identified landing pages, but it can also take into consideration dynamic search ads that have been previously generated for the landing pages, e.g., by considering the click rate of dynamic search ads that were previously associated with a particular landing page.

The interface component 304 passes a filtered set of landing page identifiers received from the filtering component 322 to a post-processing component 324. The post-processing component 324 performs plural functions, including ad creation, ranking, etc. As to the first function, the post-processing component 324 creates at least one dynamic search ad associated with each identified landing page. The post-processing component 324 performs this task by using rules-based and/or model-based functionality to automatically generate a headline of the dynamic search ad. For instance, in some implementations, the post-processing component 324 produces the headline by concatenating at least part of the query with at least part of the title of the landing page. Alternatively, or in addition, the post-processing component 324 uses a generative machine-trained model to map the query and the landing page contents to the headline. The post-processing component 324 also produces descriptive content of the ad using a rules-based and/or model-based functionality, e.g., in the same manner described above. In some implementations, the post-processing component 324 constructs other parts of the dynamic search ad based on information explicitly specified by the advertiser via the ad specification system 104, which is stored in the data store 202 (of FIG. 2). The post-processing component 324 also retrieves bidding information specified by the advertiser that is pertinent to the dynamic search ad being generated.

As to the ranking function, the post-processing component 324 ranks a candidate set of dynamic search ads (optionally together with text ads produced by one or more TA engines) based on one or more factors to produce a list of N top-ranked search ads. For a particular dynamic search ad associated with a particular landing page, the factors include any of: a) the semantic relevance of the particular landing page to the query; b) the bidding information specified by the advertiser that applies to this particular dynamic search ad; c) the popularity of the particular landing page, and so on. For a particular text ad, the factors include: a) the semantic relevance of the particular text ad to the query; b) the bidding information specified by the advertiser for the text ad; and c) the popularity of the text ad. In one illustrative case, the post-processing component 324 uses a machine-trained model to assign a click prediction score to each candidate ad that has been assessed as semantically relevant to the query. The post-processing component 324 then modifies (e.g., multiplies) the prediction score by bidding information associated with the candidate ad, to yield a ranking score.

The input 326 indicates that the post-processing component 324 optionally receives input from one or more other sources 328. For example, the other sources 328 include one or more other TA engines and/or DSA engines that do not participate in the resource sharing among the TA mode and the DSA mode described above, but that nevertheless contribute to the final ads that are provided to the user.

A delivery component 330 delivers the set of N search ads identified by the post-processing component 324. As described above, in some implementations, the delivery component 330 works in conjunction with a search system (not shown). These two components deliver a list of items that match the query, some of which correspond to ads identified by the ad-serving system 108 and others of which correspond to organic search results identified by the search system. The delivery component 330 or the search system annotates the entries in the list that correspond to ads with special identifiers.

FIG. 4 shows the operation of the ad-serving system 108 in performing the second step. As before, the preprocessing component 302 performs preprocessing on the query, to produce query information. The interface component 304 then forwards the query information to the first-mode resources 116.

The first-mode resources 116 perform the same analysis in the course of generating text ads and dynamic search ads. Further, the data fed to the first-mode resources 116 has the same interpretation in the DSA mode as it does in the TA mode. The second step can be said to share resources in the sense that it uses the output results of the first-mode processing resources 116 (which were developed to serve text ads) to now also serve dynamic search ads.

More specifically, the encoder component 306 maps the query information into a query embedding. Note that the encoder component 306 performs its encoding function only once; hence, if the query embedding has already been generated for the first step, it can be reused for the second step without regenerating it. The lookup component 308 then uses any technique to match the query embedding to keyword embeddings in the first set 312. For example, the lookup component 308 uses the approximate nearest neighbor technique to identify a candidate set of keyword embeddings (and associated keywords) that best match the query embedding. By virtue of this process, the lookup component 308 also identifies a subset of text ads because the keyword embeddings are associated with respective text ads. The other first-mode engines 318 identify other subsets of keyword embeddings. For example, assume that the representative first-mode engine 320 uses a generative machine-trained model to map the query into a set of keyword embeddings.

A keyword aggregator 402 of the interface component 304 aggregates the different subsets of keywords identified by the first-mode resources 116, to yield a master set of keywords. In doing so, the keyword aggregator 402 removes duplicate keywords identified by two or more techniques. A lookup component 404 identifies a set of landing pages associated with the master set of keywords. In some cases, the lookup component 404 performs this function by consulting a lookup table to map each keyword to an appropriate landing page. A filtering component 406 performs any environment-specific filtering on the landing pages identified by the lookup component 404. For example, the filtering component 406 excludes landing pages based on any of the considerations described above with respect to the filtering component 322 of FIG. 3.

In some cases, an offline engine (not shown) generates the lookup table used by the lookup component 404. The offline engine then periodically updates the table, e.g., to take account for new landing pages, new metadata, etc. In some cases, the offline engine generates the table using rules-based and/or model-based functionality. For example, the offline engine uses a rules-based approach to identify a landing page having a title that matches a specified keyword. Alternatively, or in addition, the offline engine uses a vector-based search to find a landing page that semantically matches a specified keyword.

The input 326 indicates that the post-processing component 324 receives information regarding other subsets of landing pages from the other sources 328 (shown in FIG. 3). These other sources 328 correspond to TA engines that generate TA ads, and DSA engines that use other techniques to identify respective subsets of landing pages compared to the processing flow described above (involving the use of the lookup component 308). The post-processing component 324 then proceeds to create and rank dynamic search ads (optionally together with text ads) in the same manner described above in connection with the first step. The delivery component 330 serves the dynamic search ads to the user who submitted the query.

To repeat, in both the examples of FIGS. 3 and 4, the ad-serving system 108 simultaneously operates in the TA mode by using, in part, the above-described keyword-identifying engines of the first-mode resources 116 to identify keywords associated with the user's query. The post-processing component 324 then retrieves the text ads that were previously associated with the identified keywords (by the ad specification system 104). The delivery component 330 serves those text ads along with the dynamic search ads.

The ad-serving system 108 provides an efficient way of serving ads for several reasons. First, the ad-serving system 108 reduces the consumption of resources because it fuses two formerly separate processing flows into integrated dual-use functionality. Second, the ad-serving system 108 simplifies the maintenance of the two processing flows because it reduces the number of operations that are unique to each processing path that need to be maintained. Third, the ad-serving system 108 allows functionality associated with the DSA mode to benefit from the advanced algorithms that have been developed for use in the TA mode. Note that, in some cases, the TA mode includes more advanced resources compared to the DSA mode because it has been in existence for a longer amount of time, and has received more research attention by developers because it serves a greater volume of ads compared to the TA mode. Fourth, the ad-serving system 108 can leverage the encoder component 306 to provide a rich representation of the query's meaning, which allows the ad-serving system 108 to simplify some of the preprocessing performed by the preprocessing component 302.

In some cases, the ad-serving system 108 further eliminates or reduces the use of intermediary identifier information. For example, in an alternative approach, an ad-serving platform maps a query to an intermediary identifier (Trigger_ID), and then maps the intermediary identifier (Trigger_ID) to a particular page (URL_ID). This solution involves the storage of a large table in memory. The large table, in turn, reduces the performance and scalability of the ad-serving platform. In some cases, the large table also makes it resource-prohibitive to run two parallel versions of the ad-serving platform, as is commonly performed when upgrading the ad-serving platform. The ad-serving system 108 described herein, by contrast, uses functionality to map a query embedding to landing page information without the use of intermediate identifiers. Therefore, the ad-serving system 108 makes more efficient use of memory compared to the above-described type of ad-serving platform.

The shared use of resources also provides a latency-efficient way of executing the TA processing flow and the DSA processing flow. For instance, in some implementations, the ad-serving system 108 performs at least some of the DSA processing operations described above in the course of producing text ads, which reduces the overall amount of time that is required to generate a full set of text ads and dynamic search ads. Further, the ad-serving system 108 relies on first-mode resources 116 to match the query to landing pages at a relatively early stage in the DSA processing flow. The ad-serving system 108 can leverage this characteristic by performing other tasks in parallel with this early-stage processing by the TA functionality.

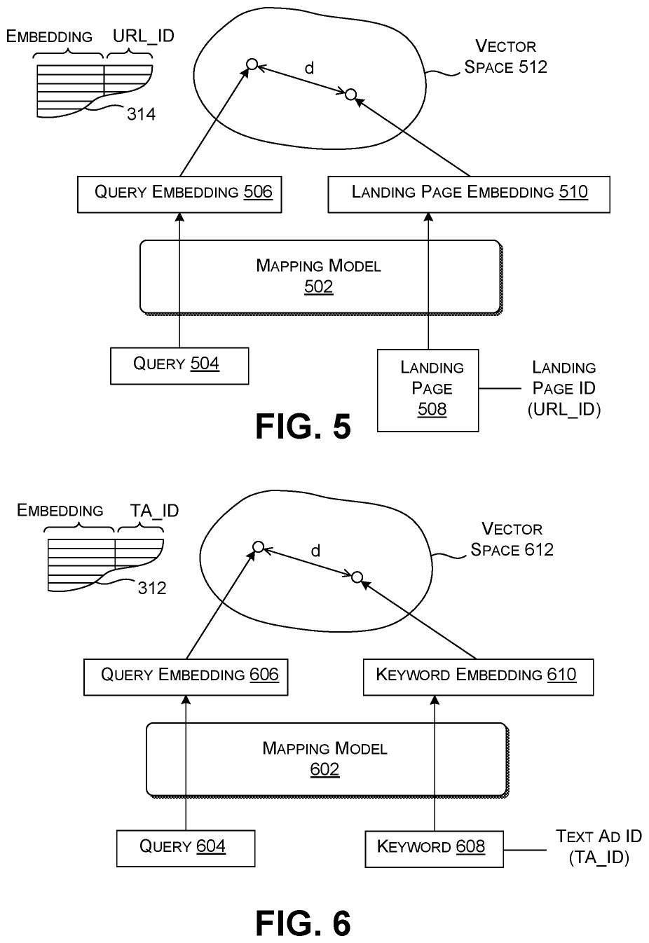

FIG. 5 shows a mapping model 502 for mapping a query 504 to a query embedding 506, and for mapping each landing page 508 to a landing page embedding 510. In some cases, the mapping model 502 specifically maps a particular part of a landing page 508, such as its title, to the landing page embedding 510. In other cases, the mapping model 502 maps the entire contents of the landing page 508 to the landing page embedding 510. As stated above, the mapping model 502 is implemented using any type of neural network, governed by machine-trained weights.

The proximity d of the query embedding 506 to the landing page embedding 510 in a vector space 512 defines a degree of similarity between the query embedding 506 and the landing page embedding 510. FIG. 5 shows the vector space 512 in two dimensions to facilitate explanation, but the vector space's dimension corresponds to the size of the embeddings. The lookup component 308 measures proximity using any distance measure, examples of which were specified above. The data store 310 includes the second set 314 of entries, each of which specifies a landing page embedding together with other metadata, such as a landing page identifier (URL_ID) associated with a particular landing page.

FIG. 6 shows a mapping model 602 for mapping a query 604 to a query embedding 606, and for mapping each keyword 608 to a keyword embedding 610. In some cases, the mapping model 602 is the same mapping model 502 shown in FIG. 6, including the same machine-trained weights. Here, the mapping model 602 maps embeddings into a vector space 612 which is the same as the vector space 512 shown in FIG. 5. In other implementations, the mapping model 602 shown in FIG. 6 uses a different set of weights compared to the weights used in the mapping model 502 of FIG. 5.

The proximity d of the query embedding 606 to the keyword embedding 610 in the vector space 612 defines a degree of similarity between the query embedding 606 and the keyword embedding 610. The lookup component 308 measures proximity using any distance measure, examples of which were specified above. The data store 310 includes the first set 312 of entries, each of which specifies a keyword embedding together with other metadata, such as a text ad identifier (TA_ID) associated with a particular keyword and its associated text ad.

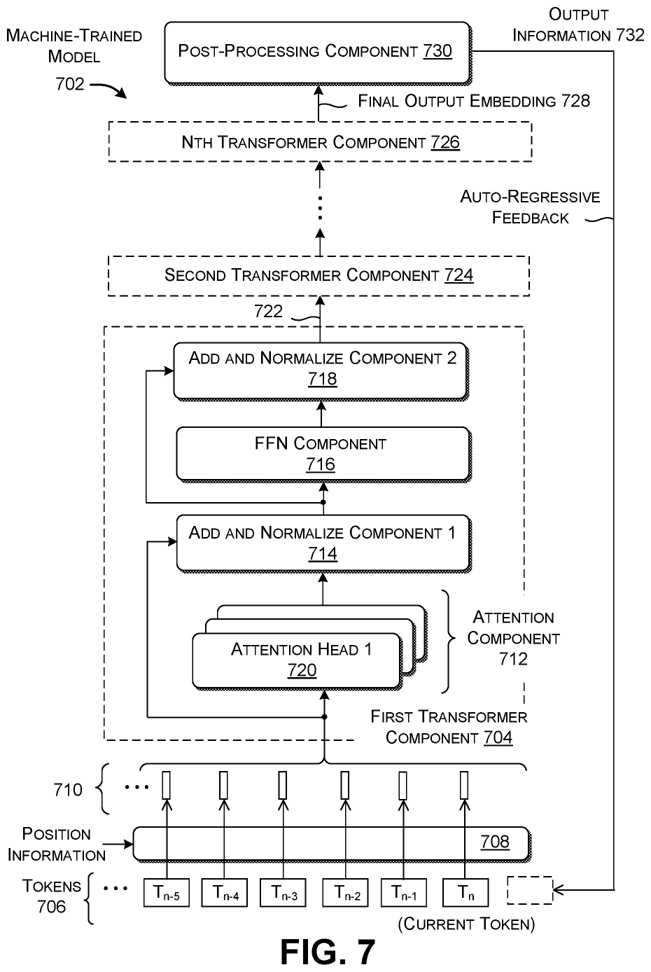

FIG. 7 shows one implementation of a machine-trained model 702 (“model”), which can be used to implement various components of the ad-serving system 108 of FIGS. 2 and 3. For instance, the encoder component 306 can use the model 702 to map input text to an embedding. The first-mode engine 320 uses the model 702 to autoregressively map input text into output text, and so on.

The model 702 is composed, in part, of a pipeline of transformer components, including a first transformer component 704. FIG. 7 provides details regarding one way to implement the first transformer component 704. Although not specifically illustrated, other transformer components of the model 702 have the same architecture and perform the same functions as the first transformer component 704 (but are governed by separate sets of weights).

The model 702 commences with the receipt of the input information. The input information includes a series of linguistic tokens 706. As used herein, a “token” or “text token” refers to a unit of text having any granularity, such as an individual word, a word fragment produced by byte pair encoding (BPE), a character n-gram, a word fragment identified by the WordPiece algorithm or SentencePiece algorithm, etc. To facilitate explanation, assume that each token corresponds to a complete word.

Next, an embedding component 708 maps the sequence of tokens 706 into respective embedding vectors. For example, the embedding component 708 produces one-hot vectors that describe the tokens, and then uses a machine-trained linear transformation to map the one-hot vectors into the embedding vectors. The embedding component 708 then adds position information to the respective embedding vectors, to produce position-supplemented embedded vectors 710. The position information added to each embedding vector describes the embedding vector's position in the sequence of embedding vectors.

The first transformer component 704 operates on the position-supplemented embedding vectors 710. In some implementations, the first transformer component 704 includes, in order, an attention component 712, a first add-and-normalize component 714, a feed-forward neural network (FFN) component 716 and a second add-and-normalize component 718.

The attention component 712 performs attention analysis using the following equation:

$$attn ( Q , K , V ) = Soft max ( \frac{{QK}^{T}}{\sqrt{d}} ) V . \qquad ( 1 )$$

The attention component 712 produces query information Q by multiplying the position-supplemented embedding vectors 710 (or, in some applications, just a last position-supplemented embedding vector associated with a last-received token) by a query weighting matrix W^{Q}. Similarly, the attention component 712 produces key information K and value information V by multiplying the position-supplemented embedding vectors 710 by a key weighting matrix W^{K} and a value weighting matrix W^{V}, respectively. To execute Equation (1), the attention component 712 takes the dot product of Q with the transpose of K, and then divides the dot product by a scaling factor \sqrt{d}, to produce a scaled result The symbol d represents the dimensionality of Q and K. The attention component 712 takes the Softmax (normalized exponential function) of the scaled result, and then multiplies the result of the Softmax operation by V, to produce attention output information. More generally stated, the attention component 712 determines how much emphasis should be placed on parts of the input information when interpreting other parts of the input information. In some cases, the attention component 712 is said to perform masked attention insofar as the attention component 712 masks output token information that, at any given time, has not yet been determined. Background information regarding the general concept of attention is provided in Vaswani, et al., “Attention Is All You Need,” arXiv, Cornell University, arXiv: 1706.03762v5 [cs.CL], Dec. 6, 2017, 15 pages.

Note that FIG. 7 shows that the attention component 712 is composed of plural attention heads, including a representative attention head 720. Each attention head performs the computations specified by Equation (1), but with respect to a particular representational subspace that is different than the subspaces of the other attention heads. To accomplish this operation, the attention heads perform the computations described above using different respective sets of query, key, and value weight matrices. Although not shown, the attention component 712 concatenates the output results of the attention component's separate attention heads, and then multiplies the results of this concatenation by another weight matrix W^{O}.

The add-and-normalize component 714 includes a residual connection that combines (e.g., sums) input information fed to the attention component 712 with the output information generated by the attention component 712. The add-and-normalize component 714 then normalizes the output information generated by the residual connection, e.g., by normalizing values in the output information based on the mean and standard deviation of those values. The other add-and-normalize component 718 performs the same functions as the first-mentioned add-and-normalize component 714. The FFN component 716 transforms input information to output information using a feed-forward neural network having any number of layers.

The first transformer component 704 produces an output embedding 722. A series of other transformer components (724, . . . , 726) perform the same functions as the first transformer component 704, each operating on an output embedding produced by its immediately preceding transformer component. Each transformer component uses its own level-specific set of machine-trained weights. The final transformer component 726 in the model 702 produces a final output embedding 728.

A post-processing component 730 performs post-processing operations on the final output embedding 728, to produce the final output information 732. In one case, for instance, the post-processing component 730 performs a machine-trained linear transformation on the final output embedding 728, and processes the result of this transformation using a Softmax component (not shown).

In some implementations, the model 702 operates in an auto-regressive manner. To operate in this way, the post-processing component 730 uses the Softmax operation to predict a next token (or, in some cases, a set of the most probable next tokens). The model 702 then appends the next token to the end of the sequence of input tokens 706, to provide an updated sequence of tokens. In a next pass, the model 702 processes the updated sequence of tokens to generate a next output token. The model 702 repeats the above process until it generates a specified stop token.

Other implementations use other model architectures to implement any component of the ad-serving system 108. These other architectures include recurrent neural networks (RNNs), other types of attention-based models, and so on. For example, the first-mode engine 320 can use a sequence-to-sequence RNN to map input text (e.g., corresponding to an input query) to output text (e.g., corresponding to a keyword).

A training system (not shown) trains the weights of the model 702, e.g., using stochastic gradient descent in combination with back propagation. The training system uses any loss function to assess error. For example, consider the training of a machine-trained model that will govern the operation of the encoder component 306 in the first step (of FIG. 3). The training system performs training based on a corpus of training examples, each of which includes a particular query, a particular landing page, and a particular label. The label constitutes ground-truth information that specifies a degree to which the query matches the landing page. The training system determines the error for this training example by predicting the similarity between the query and the landing page using the model 702 (in its current state of training), and then determining the extent to which the prediction varies from the ground-truth information. Overall, the training system iteratively reduces the errors between respective predictions and instances of ground-truth information. The training examples can also include negative training examples, in which the particular query and the landing page are not related. A “hard” negative is a training example for which the query and the landing page are not related, yet they share some similar characteristics. In practice, the training system processes batches of training examples.

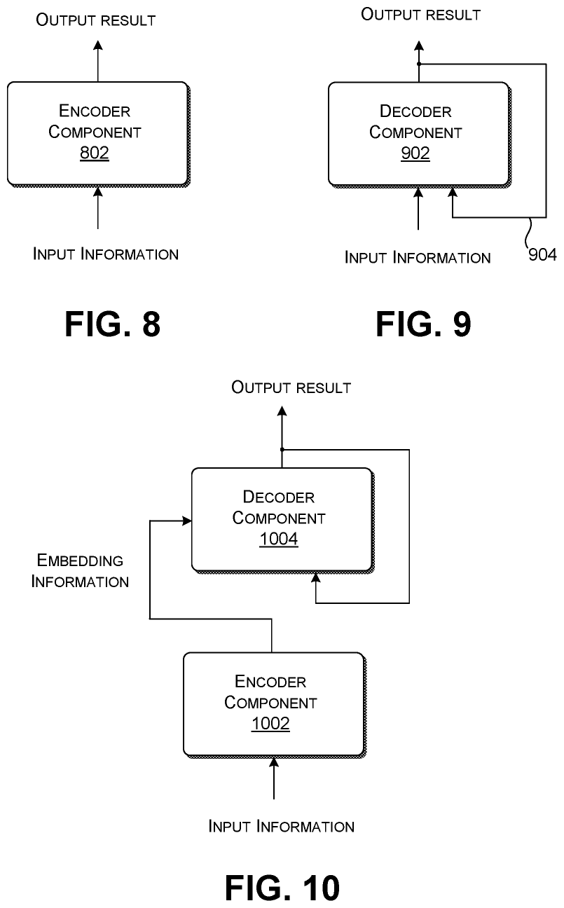

Different model architectures can make use of the model 702 of FIG. 7. For example, FIG. 8 shows a standalone encoder component 802 that uses the model 702 to map input information to an output result in a single pass. For example, in some implementations, the output result corresponds to an embedding, expressed as hidden state information. The hidden state information includes a hidden state vector for each text token of the input information. In some implementations, a downstream component relies on all of the hidden state vectors, or just a representative first hidden state vector (e.g., corresponding to an encoded counterpart of a special CLS token in the input information).

FIG. 9 shows a standalone decoder component 902 that autoregressively maps input information to an output result, such as output text. The feedback path 904 represents the operation of adding a predicted output token (or plural candidate output tokens) to the end the previously-processed input information.

FIG. 10 shows an encoder-decoder arrangement including an encoder component 1002 coupled to a decoder component 1004. That is, the encoder component 1002 maps input information to an output embedding. The decoder component 1004 autoregressively produces an output result based on the output embedding provided by the encoder component 1002.

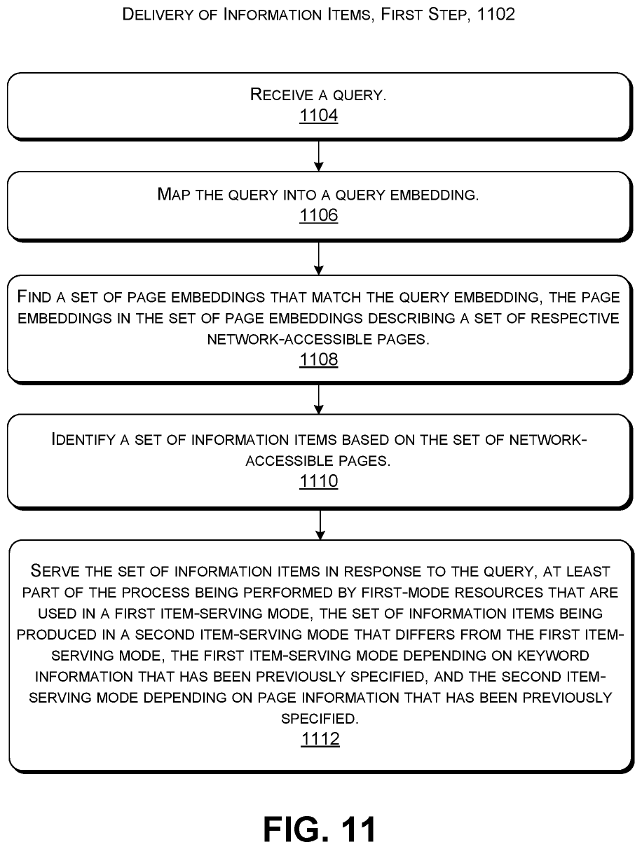

FIG. 11 shows a process 1102 for serving information items according to the first step shown in FIG. 3. The following general information applies to all processes described in this Detailed Description, including the process 1102. The process 1102 is expressed as a series of operations performed in a particular order. But the order of these operations is merely representative, and the operations are capable of being varied in other implementations. Further, any two or more operations described below can be performed in a parallel manner. In one implementation, the blocks shown in the process 1102 that pertain to processing-related functions are implemented by the hardware logic circuitry described in connection with FIGS. 13 and 14, which, in turn, is implemented by one or more processors, a computer-readable storage medium, etc.

In block 1104, the ad-serving system 108 receives a query. In block 1106, the ad-serving system 108 maps the query into a query embedding. In block 1108, the ad-serving system 108 finds a set of page embeddings that match the query embedding, the page embeddings in the set of page embeddings describing a set of respective network-accessible pages (e.g., landing pages). In block 1110, the ad-serving system 108 identifies a set of information items (e.g., dynamic search ads) based on the set of network-accessible pages. In block 1112, the ad-serving system 108 serves the set of information items in response to the query. At least part of the process 1102 is performed by the first-mode resources 116 that are used in a first item-serving mode (e.g., the text ad-serving mode). The set of information items are produced in a second item-serving mode (e.g., the dynamic search ad-serving mode) that differs from the first item-serving mode. The first item-serving mode depends on keyword information that has been previously specified, and the second item-serving mode depends on page information that has been previously specified. In some implementations, advertisers supply the keyword information via the ad specification system 104 by specifying keywords, and advertisers supply the landing page information via the ad specification system 104 by specifying landing pages.

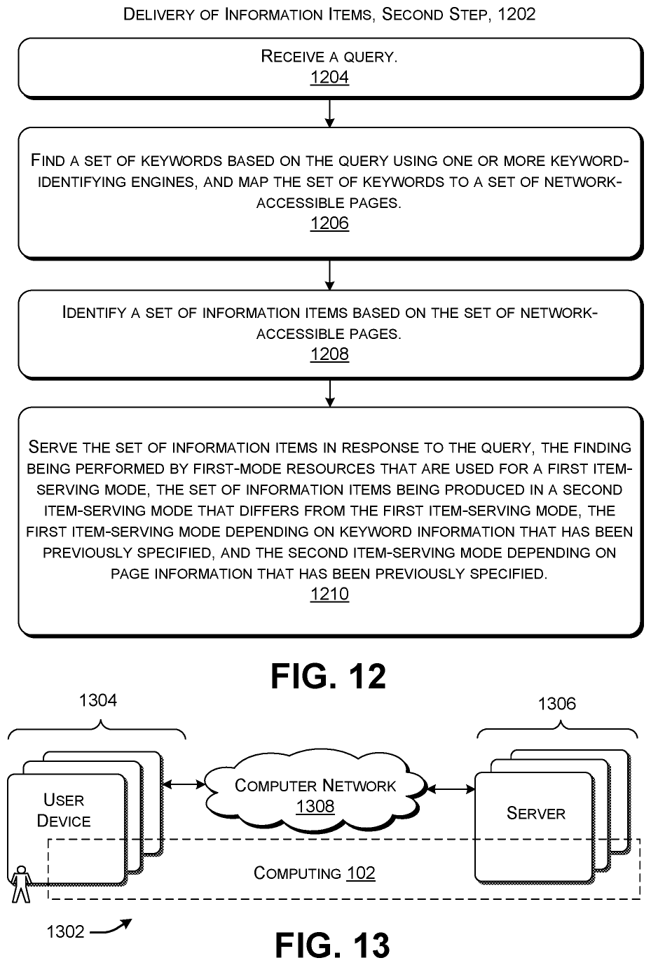

FIG. 12 shows a process 1202 for serving information items according to the second step shown in FIG. 4. In block 1204, the ad-serving system 108 receives a query. In block 1206, the ad-serving system 108 finds a set of keywords based on the query using one or more keyword-identifying engines, and maps the set of keywords to a set of network-accessible pages (e.g., landing pages). In block 1208, the ad-serving system 108 identifies a set of information items (e.g., dynamic search ads) based on the set of network-accessible pages. In block 1210, the ad-serving system 108 serves the set of information items in response to the query. The finding operation in block 1206 is performed by the first-mode resources 116 that are used for a first item-serving mode (e.g., the text ad-serving mode). The set of information items are produced in a second item-serving mode (e.g., the dynamic search ad-serving mode) that differs from the first item-serving mode. The first item-serving mode depends on keyword information that has been previously specified, and the second item-serving mode depends on page information that has been previously specified.

FIG. 13 shows computing equipment 1302 that, in some implementations, is used to implement the computing system 102 of FIGS. 1 and 2, including the ad-serving system 108 shown in FIGS. 3 and 4. The computing equipment 1302 includes a set of user devices 1304 coupled to a set of servers 1306 via a computer network 1308. Each user device corresponds to any type of computing device, including any of a desktop computing device, a laptop computing device, a handheld computing device of any type (e.g., a smartphone or a tablet-type computing device), a mixed reality device, an intelligent appliance, a wearable computing device (e.g., a smart watch), an Internet-of-Things (IoT) device, a gaming system, a media device, a vehicle-borne computing system, any type of robot computing system, a computing system in a manufacturing system, etc. In some implementations, the computer network 1308 is implemented as a local area network, a wide area network (e.g., the Internet), one or more point-to-point links, or any combination thereof.

The dashed-line box in FIG. 13 indicates that the functionality of the computing system 102 is capable of being spread across the user devices 1304 and/or the servers 1306 in any manner. For instance, in some cases, each user device, or a group of affiliated user devices, implements the entirety the computing system 102. In other cases, the servers 1316 implement the entirety of the computing system 102; here, a user may interact with the servers 1306 via a browser application provided by a user device. In other cases, the functionality of the computing system 102 is shared between each user device and the servers 1306.

FIG. 14 shows a computing system 1402 that, in some implementations, is used to implement any aspect of the mechanisms set forth in the above-described figures. For instance, in some implementations, the type of computing system 1402 shown in FIG. 14 is used to implement any user device or any server shown in FIG. 13. In all cases, the computing system 1402 represents a physical and tangible processing mechanism.

The computing system 1402 includes a processing system 1404 including one or more processors. The processor(s) include one or more Central Processing Units (CPUs), and/or one or more Graphics Processing Units (GPUs), and/or one or more Application Specific Integrated Circuits (ASICs), and/or one or more Neural Processing Units (NPUs), etc. More generally, any processor corresponds to a general-purpose processing unit or an application-specific processor unit.

The computing system 1402 also includes computer-readable storage media 1406, corresponding to one or more computer-readable media hardware units. The computer-readable storage media 1406 retains any kind of information 1408, such as machine-readable instructions, settings, model weights, and/or other data. In some implementations, the computer-readable storage media 1406 includes one or more solid-state devices, one or more magnetic hard disks, one or more optical disks, magnetic tape, etc. Any instance of the computer-readable storage media 1406 uses any technology for storing and retrieving information. Further, any instance of the computer-readable storage media 1406 represents a fixed or removable unit of the computing system 1402. Further, any instance of the computer-readable storage media 1406 provides volatile and/or non-volatile retention of information.

More generally, any of the storage resources described herein, or any combination of the storage resources, is to be regarded as a computer-readable medium. In many cases, a computer-readable medium represents some form of physical and tangible entity. The term computer-readable medium also encompasses propagated signals, e.g., transmitted or received via a physical conduit and/or air or other wireless medium. However, the specific term “computer-readable storage medium” or “storage device” expressly excludes propagated signals per se in transit, while including all other forms of computer-readable media; a computer-readable storage medium or storage device is “non-transitory” in this regard.

The computing system 1402 utilizes any instance of the computer-readable storage media 1406 in different ways. For example, in some implementations, any instance of the computer-readable storage media 1406 represents a hardware memory unit (such as random access memory (RAM)) for storing information during execution of a program by the computing system 1402, and/or a hardware storage unit (such as a hard disk) for retaining/archiving information on a more permanent basis. In the latter case, the computing system 1402 also includes one or more drive mechanisms 1410 (such as a hard drive mechanism) for storing and retrieving information from an instance of the computer-readable storage media 1406.

In some implementations, the computing system 1402 performs any of the functions described above when the processing system 1404 executes computer-readable instructions stored in any instance of the computer-readable storage media 1406. For instance, in some implementations, the computing system 1402 carries out computer-readable instructions to perform each block of the processes described in with reference to FIGS. 11 and 12. FIG. 14 generally indicates that hardware logic circuitry 1412 includes any combination of the processing system 1404 and the computer-readable storage media 1406.

In addition, or alternatively, the processing system 1404 includes one or more other configurable logic units that perform operations using a collection of logic gates. For instance, in some implementations, the processing system 1404 includes a fixed configuration of hardware logic gates, e.g., that are created and set at the time of manufacture, and thereafter unalterable. In addition, or alternatively, the processing system 1404 includes a collection of programmable hardware logic gates that are set to perform different application-specific tasks. The latter category of devices includes Programmable Array Logic Devices (PALs), Generic Array Logic Devices (GALs), Complex Programmable Logic Devices (CPLDs), Field-Programmable Gate Arrays (FPGAs), etc. In these implementations, the processing system 1404 effectively incorporates a storage device that stores computer-readable instructions, insofar as the configurable logic units are configured to execute the instructions and therefore embody or store these instructions.

In some cases (e.g., in the case in which the computing system 1402 represents a user computing device), the computing system 1402 also includes an input/output interface 1414 for receiving various inputs (via input devices 1416), and for providing various outputs (via output devices 1418). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1420 and an associated graphical user interface presentation (GUI) 1422. The display device 1420 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1402 also includes one or more network interfaces 1424 for exchanging data with other devices via one or more communication conduits 1426. One or more communication buses 1428 communicatively couple the above-described units together.

The communication conduit(s) 1426 are implemented in any manner, e.g., by a local area computer network, a wide area computer network (e.g., the Internet), point-to-point connections, or any combination thereof. The communication conduit(s) 1426 include any combination of hardwired links, wireless links, routers, gateway functionality, name servers, etc., governed by any protocol or combination of protocols.

FIG. 14 shows the computing system 1402 as being composed of a discrete collection of separate units. In some cases, the collection of units corresponds to discrete hardware units provided in a computing device chassis having any form factor. FIG. 14 shows illustrative form factors in its bottom portion. In other cases, the computing system 1402 includes a hardware logic unit that integrates the functions of two or more of the units shown in FIG. 1. For instance, in some implementations, the computing system 1402 includes a system on a chip (SoC or SOC), corresponding to an integrated circuit that combines the functions of two or more of the units shown in FIG. 14.

The following summary provides a set of illustrative examples of the technology set forth herein.

(A1) According to a first aspect, a method (e.g., the process 1102) is described for serving information items. The method includes: receiving (e.g., 1104) a query; mapping (e.g., 1106) the query into a query embedding; finding (e.g., 1108) a set of page embeddings that match the query embedding, the page embeddings in the set of page embeddings describing a set of respective network-accessible pages; identifying (e.g., 1110) a set of information items based on the set of network-accessible pages; and serving (e.g., 1112) the set of information items in response to the query. At least part of the method is performed by first-mode resources (e.g., 116) that are used in a first item-serving mode. The set of information items is produced in a second item-serving mode that differs from the first item-serving mode. The first item-serving mode depends on keyword information that has been previously specified, and the second item-serving mode depends on page information that has been previously specified.

(A2) According to some implementations of the method of A1, the first item-serving mode is a text ad-serving mode for serving text ads, and the second item-serving mode is a dynamic search ad-serving mode for serving dynamic search ads.

(A3) According to some implementations of the methods of A1 or A2, the mapping and the finding are performed by the first-mode resources.

(A4) According to some implementations of any individual method of A1-A3, the mapping is performed by using a machine-trained model, and each page embedding is produced using the machine-trained model.

(A5) According to some implementations of any individual method of A1-A4, the finding is performed using a vector-based nearest-neighbor search algorithm.

(A6) According to some implementations of any individual method of A1-A5, the method further includes filtering the set of network-accessible pages to remove a subset of the set of network-accessible pages that do not meet a prescribed quality test.

(A7) According to some implementations of any individual method of A1-A6, the mapping and the finding are associated with a first step of the method, and a second step of the method includes: finding a set of keywords based on the query using one or more keyword-identifying engines implemented using the first-mode resources; and mapping the set of keywords to another set of network-accessible pages. The identifying of the set of information items is also based on the aforementioned another set of landing pages identified in the second step.

(A8) According to some implementations of the method of A7, one keyword-identifying engine operates by finding a subset of keyword embeddings that match the query embedding, the keyword embeddings in the set of keyword embeddings describing respective keywords.

(A9) According to some implementations of the method of A8, the mapping of the query is performed using a machine-trained model, and each keyword embedding in the subset of keyword embeddings is produced using the machine-trained model.

(A10) According to some implementations of the method of A8 or A9, the finding of the subset of keyword embeddings is performing using a vector-based neighbor search algorithm.

(A11) According to some implementations of any individual method of A8-A10, the mapping of the set of keywords to the aforementioned another set of network-accessible pages is performed using a lookup table.

(A12) According to some implementations of any individual method of A8-A11, one keyword-identifying engine operates by using a generative machine-trained model to map the query into a subset of keywords.

(A13) According to some implementations of any individual method of A7-A12, the finding of the set of keywords involves aggregating plural subsets of keywords produced by plural respective keyword-identifying engines.

(A14) According to some implementations of any individual method of A7-A13, the method further includes filtering the aforementioned another set of network-accessible pages to remove a subset of the aforementioned another set of network-accessible pages that do not meet a prescribed quality test.

(B1) According to a second aspect, another method (e.g., the process 1202) is described for serving information items. The method includes: receiving (e.g., 1204) a query; finding (e.g., 1206) a set of keywords based on the query using one or more keyword-identifying engines, and mapping the set of keywords to a set of network-accessible pages; identifying (e.g., 1208) a set of information items based on the set of network-accessible pages; and serving (e.g., 1210) the set of information items in response to the query. The finding is performed by first-mode resources (e.g., 116) that are used for a first item-serving mode. The set of information items is produced in a second item-serving mode that differs from the first item-serving mode. The first item-serving mode depends on keyword information that has been previously specified, and the second item-serving mode depends on page information that has been previously specified.

In yet another aspect, some implementations of the technology described herein include a computing system (e.g., the computing system 1402) that includes a processing system (e.g., the processing system 1404). The computing system also includes a storage device (e.g., the computer-readable storage media 1406) for storing computer-readable instructions (e.g., information 1408). The processing system executes the computer-readable instructions to perform any of the methods described herein (e.g., any individual method of the methods of A1-A14 and B1).

In yet another aspect, some implementations of the technology described herein include a computer-readable storage medium (e.g., the computer-readable storage media 1406) for storing computer-readable instructions (e.g., the information 1408). A processing system (e.g., the processing system 1404) executes the computer-readable instructions to perform any of the operations described herein (e.g., the operation in any individual method of the methods of A1-A14 and B1).

More generally stated, any of the individual elements and steps described herein are combinable into any logically consistent permutation or subset. Further, any such combination is capable of being be manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

As to terminology used in this description, the phrase “configured to” encompasses various physical and tangible mechanisms for performing an identified operation. The mechanisms are configurable to perform an operation using the hardware logic circuity 1412 of FIG. 14. The term “logic” likewise encompasses various physical and tangible mechanisms for performing a task. For instance, each processing-related operation illustrated in the flowcharts of FIGS. 11 and 12 corresponds to a logic component for performing that operation.

This description may have identified one or more features as optional. This type of statement is not to be interpreted as an exhaustive indication of features that are to be considered optional; generally, any feature is to be considered as optional, although not explicitly identified in the text, unless otherwise noted. Further, any mention of a single entity is not intended to preclude the use of plural such entities; similarly, a description of plural entities in the specification is not intended to preclude the use of a single entity. As such, a statement that an apparatus or method has a feature X does not preclude the possibility that it has additional features. Further, any features described as alternative ways of carrying out identified functions or implementing identified mechanisms are also combinable together in any combination, unless otherwise noted.

In terms of specific terminology, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1-20. (canceled)

21. A computing system for serving ad content, comprising:
a first data store for storing computer-readable instructions;
a second data store for storing particular keyword embeddings, each of the particular keyword embeddings including a particular keyword embedding together with metadata that identifies a particular keyword that has been previously specified and an associated particular text ad, a neural network having produced the particular keyword embeddings based on particular keywords; and
a processing system for executing the computer-readable instructions to perform operations that include:
receiving a query submitted by a browser application to a search engine;
encoding the query into a query embedding using the neural network, the neural network being governed by machine-trained weights produced by a training system based on training examples, the query embedding being a distributed vector;
identifying a set of keywords that match the query embedding by finding keyword embeddings in the second data store that are closest to the query embedding;
identifying a set of text ads based on the set of keywords;
mapping the set of keywords to a first set of landing pages by consulting a lookup table produced by an offline engine, each of the landing pages being accessible via a particular URL;
generating a first set of dynamic search ads based on the first set of landing pages;
ranking the set of text ads and the first set of dynamic search ads based on one or more factors, to produce a set of top-ranked ads; and
serving the top-ranked ads to the browser application in response to the query,
the computing system reducing consumption of processing resources by integrating processing flows for generating the set of text ads and the first set of dynamic search ads using dual-use functionality, the dual-use functionality including the neural network and the particular keyword embeddings in the second data store.

22. The computing system of claim 21, wherein the finding keyword embeddings is performed using a vector-based nearest-neighbor search algorithm.

23. The computing system of claim 21, wherein the operations further comprise:
receiving additional keywords produced by one or more keyword-identifying engines;
mapping the additional keywords into an additional set of landing pages; and
identifying one or more additional text ads based on the additional keywords and/or one or more additional dynamic search ads based on the additional set of landing pages.

24. The computing system of claim 23, wherein one of the one or more keyword-identifying engines operate by using a generative machine-trained model to map the query into a subset of additional keywords.

25. The computing system of claim 21, wherein the operations further comprise filtering the first set of landing pages to remove a subset of the first subset of landing pages that do not meet a prescribed quality test.

26. The computing system of claim 21, wherein the second data store also stores particular landing page embeddings, each of the particular landing page embeddings including a particular landing page embedding together with metadata that identifies a particular landing page that has been previously specified, the operations further comprising:
identifying a second set of landing pages by finding landing page embeddings in the second data store that are closest to the query embedding; and
generating a second set of dynamic search ads based on the second set of landing pages,
wherein the ranking also ranks the second set of dynamic search ads.

27. The computing system of claim 26, wherein the finding landing page embeddings is performed using a vector-based nearest-neighbor search algorithm.

28. The computing system of claim 26, further comprising filtering the second set of landing pages to remove a subset of the second set of landing pages that do not meet a prescribed quality test, the filtering comprising determining semantic similarity between the query and each landing page in the second set of landing pages.

29. The computing system of claim 28, wherein the determining semantic similarity comprises determining a distance between a first distributed vector that represents the query and a second distributed vector that represents a particular landing page in the second set of landing pages.

30. The computing system of claim 21,
wherein first-mode processing resources are used to serve the text ads,
wherein second-mode processing resources, in combination with the first-mode processing resources, are used to serve the first set of dynamic search ads, and
wherein development of the first-mode processing resources precedes development of the second-mode processing resources.

31. The computing system of claim 21, wherein the operations further comprise:
identifying other content items based on the query using the search engine; and
mixing the text ads and the first set of dynamic search ads with the other content items to produce mixed content for presentation in a search page provided by the search engine to the browser application.

32. A method for developing a computing system for serving ad content, comprising:
developing first-mode processing resources to serve text ads, the developing including training a neural network based on training examples, using the neural network to encode particular keywords into particular query embeddings, and storing the particular query embeddings in a data store, each of the particular keyword embeddings including a particular keyword embedding together with metadata that identifies a particular keyword and an associated particular text ad;
after developing the first-mode processing resources, developing second-mode processing resources to serve dynamic search ads in combination with at least some of the first-mode processing resources; and
the first-mode and second-mode processing resources being configured to perform operations comprising:
receiving a query submitted by a browser application to a search engine;
encoding the query into a query embedding using the neural network, the neural network being governed by machine-trained weights produced in the developing first-mode processing resources, the query embedding being a distributed vector;
identifying a set of keywords that match the query embedding by finding keyword embeddings in the data store that are closest to the query embedding;
identifying a set of text ads based on the set of keywords;
mapping the set of keywords to a first set of landing pages by consulting a lookup table produced by in developing the second-mode processing resources, each of the landing pages being accessible via a particular URL;
generating a first set of dynamic search ads based on the first set of landing pages;
ranking the set of text ads and the first set of dynamic search ads based on one or more factors, to produce a set of top-ranked ads; and
serving the top-ranked ads in response to the query to the browser application,
the computing system reducing consumption of processing resources by integrating processing flows for generating the set of text ads and the first set of dynamic search ads using dual-use functionality, the dual-use functionality including the neural network and the particular keyword embeddings in the data store.

33. The method of claim 32, further comprising:
receiving additional keywords produced by one or more keyword-identifying engines;
mapping the additional keywords into an additional set of landing pages; and
identifying one or more additional text ads based on the additional keywords and/or one or more additional dynamic search ads based on the additional set of landing pages.

34. The method of claim 32, wherein the data store also stores particular landing page embeddings produced by the second-mode processing resources, each of the particular landing page embeddings including a particular landing page embedding together with metadata that identifies a particular landing page that has been previously specified, and wherein the method further comprises:
identifying a second set of landing pages by finding landing page embeddings in the data store that are closest to the query embedding; and
generating a second set of dynamic search ads based on the second set of landing pages,
wherein the ranking also ranks the second set of dynamic search ads.

35. The method of claim 34, further comprising filtering the second set of landing pages to remove a subset of the second set of landing pages that do not meet a prescribed quality test, the filtering comprising determining semantic similarity between the query and each landing page in the second set of landing pages.

36. The method of claim 35, wherein the determining semantic similarity comprises determining a distance between a first distributed vector that represents the query and a second distributed vector that represents a particular landing page in the second set of landing pages.

37. The method of claim 32, further comprising:
identifying other content items based on the query using the search engine; and
mixing the text ads and the first set of dynamic search ads with the other content items to produce mixed content for presentation in a search page provided by the search engine to the browser application.

38. A non-transitory computer-readable storage medium for storing data and computer-readable instructions, a processing system executing the computer-readable instructions to perform operations, the operations comprising:
receiving a query submitted by a browser application to a search engine;
encoding the query into a query embedding using a neural network, the neural network being governed by machine-trained weights produced by a training system based on training examples, the query embedding being a distributed vector;
identifying a set of keywords that match the query embedding by finding keyword embeddings in a data store of particular keyword embeddings that are closest to the query embedding,
each of the particular keyword embeddings in the data store including a particular keyword embedding together with metadata that identifies a particular keyword that has been previously specified and an associated particular text ad,
the data store also storing particular landing page embeddings, each of the particular landing page embeddings including a particular landing page embedding together with metadata that identifies a particular landing page that has been previously specified;
identifying a set of text ads based on the set of keywords;
mapping the set of keywords to a first set of landing pages by consulting a lookup table produced by an offline engine, each of the landing pages being accessible via a particular URL;
generating a first set of dynamic search ads based on the first set of landing pages;
identifying a second set of landing pages by finding landing page embeddings in the data store that are closest to the query embedding;
generating a second set of dynamic search ads based on the second set of landing pages;
ranking the set of text ads, the first set of dynamic search ads, and the second set of dynamic search ads based on one or more factors, to produce a set of top-ranked ads; and
serving the top-ranked ads in response to the query to the browser application,
the operations reducing consumption of processing resources by integrating processing flows for generating the set of text ads and the first set of dynamic search ads using dual-use functionality, the dual-use functionality including the neural network and the particular keyword embeddings in the data store.

39. The non-transitory computer-readable medium of claim 38, further comprising filtering the second set of landing pages to remove a subset of the second set of landing pages that do not meet a prescribed quality test, the filtering comprising determining semantic similarity between the query and each landing page in the second set of landing pages.

40. The non-transitory computer-readable storage medium of claim 38, wherein the operations further comprise:
identifying other content items based on the query using the search engine; and
mixing the text ads and the first and second sets of dynamic search ads with the other content items to produce mixed content for presentation in a search page provided by the search engine to the browser application.
